(19) United States
(12) Patent Application Publication
(10) Pub. No.: US 2022/0364248 A1
(43) Pub. Date: Nov. 17, 2022

(54) ELECTROLYTIC OIL EXTRACTION SYSTEM AND PROCESS

(71) Applicant: Guardian Partners, LLC, Denver, CO (US)

(72) Inventors: Michael J. PETERS, Denver, CO (US); John D. BREEDLOVE, Denver, CO (US); Darin JENSEN, Denver, CO (US); Seth Robert MAYER, Denver, CO (US); Christoper M. PETERS, Denver, CO (US)

(21) Appl. No.: 17/663,361

(22) Filed: May 13, 2022

Related U.S. Application Data
(60) Provisional application No. 63/188,330, filed on May 13, 2021.

(51) Int. Cl. C25B 3/03; C25B 15/033; C25B 15/031; C25B 15/08

(52) U.S. Cl. CPC C25B 3/03; C25B 15/033; C25B 15/031; C25B 15/083; C25B 15/085

(57) ABSTRACT

Systems and methods for use in extracting oil from solid plant-based materials are described. The systems and methods use an electrolyzed carrier fluid made from a hydroxide brine for contacting with plant-based material to thereby separate oil from solid plant particulate. The electrolyzed carrier fluid can have a reductive oxidation-reduction-potential (ORP) of −700 mV or more, such as in the range of from about −900 mV to about −1000 mV.

### CROSS-REFERENCE TO RELATED APPLICATION(S)

The present application claims priority under 35 U.S.C. § 119(e) to U.S. Provisional Patent Application No. 63/188,330, filed May 13, 2021, the entirety of which is hereby incorporated by reference.

### BACKGROUND

Many plant-based materials contain or can be processed to provide an oil. For example, sunflower seeds can be processed to separate sunflower oil therefrom, soybeans can be processed to separate soybean oil therefrom, coconut can be processed to separate coconut oil therefrom, etc. These plant-derived oils have a multitude of uses, from being suitable for use in foods, to cosmetics, and even in the production of fuel.

However, most known techniques for extracting oil from plant-based material suffer from one or more drawbacks. In some cases, the oil extraction processes are inefficient, and do not produce suitable amounts of oil. In other cases, the extraction processes are complex. In still other cases, the extraction processes are expensive. Some extraction processes are bad for the environment and may require the use of harmful chemicals. Certain processes can also concentrate contaminants found within the oils or exacerbate their creation, sometimes in excess of regulatory limits. And furthermore, in some cases the extraction processes are incapable of extracting oil from specific types of source material.

Accordingly, a need exists for improved methods and systems for extracting oil from plant-based materials.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

The present disclosure provides a description of various embodiments of systems and methods for use in extracting oil from solid plant-based materials, including compositions that include therein plant-based materials, such as compositions formed as a byproduct of various processes in which plant-based material is used as a feed stock.

The systems and methods for treating solid, oil-containing plant-based materials described herein may generally employ an electrolyzed carrier fluid wherein the treatment of the plant-based material with the electrolyzed carrier fluid assists in separating oil from the plant-based material while minimizing the addition, creation or concentration of undesirable compounds in the process.

In some embodiments, this disclosure provides a treatment system for extracting an oil component from a plant-based particle. The system may include a vessel for producing an electrolyzed carrier fluid and a vessel for treating plant-based material with the electrolyzed carrier fluid. During treatment, oil from the plant-based material is extracted or separated from the plant-based material and is carried by the electrolyzed carrier fluid. The system may therefore also include a vessel for separating the electrolyzed fluid (having oil contained therein) from the plant-based material, and a vessel for separating extracted/separated oil from the electrolyzed carrier fluid.

In some embodiments, this disclosure provides a method including contacting plant-based material or a composition including plant-based material with an electrolyzed carrier fluid having a reductive potential, separating the electrolyzed carrier fluid from the plant-based material, and separating an extracted/separated oil from the separated electrolyzed carrier fluid.

These and other aspects of the technology described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWINGS

Non-limiting and non-exhaustive embodiments of the disclosed technology, including the preferred embodiment, are described with reference to the following figures, wherein like reference numerals refer to like parts throughout the various views unless otherwise specified.

FIG. 1 is a step wise flow diagram of a method for extracting oil from a plant-based material configured in accordance with various embodiments described herein.

FIGS. 2A and 2B are schematic diagrams of various configurations of a fluid electrolyzation system configured in accordance with various embodiments described herein.

FIG. 3 is a schematic diagram of an oil extraction system configured in accordance with various embodiments described herein.

FIG. 4 is a schematic diagram of an ethanol production system.

### DETAILED DESCRIPTION

Embodiments are described more fully below with reference to the accompanying Figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

As indicated above, the present disclosure is directed to systems and processes for extracting oil from plant-based material. The technology described herein utilizes an electrolytic carrier fluid which directly alters the electrochemical state of the plant-based material and changes the Zeta potential at the solid-liquid interface between the solid component of the plant-based material and an oil component of the plant-based material. The carrier fluid is electrolyzed by a system described herein in which electrons are added to the carrier fluid in a manner that minimizes conversion of potentially undesirable aspects within the carrier fluid.

In the following description, reference is made to the accompanying drawing that forms a part hereof and in which is shown by way of illustration at least one specific implementation. The following description provides additional specific implementations. It is to be understood that other implementations are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples, including the figures, provided below. In some instances, a reference numeral may have an associated sub-label consisting of a lower-case letter to denote one of multiple similar components. When reference is made to a reference numeral without specification of a sub-label, the reference is intended to refer to all such multiple similar components.

Methods and systems described herein generally relate to the extraction, separation, and/or removal of oil from plant-based materials. The plant-based material from which oil is extracted, removed and/or separated via the methods and systems described herein can generally include (1) whole plant-based material, (2) plant-based material that has been subjected to cutting, chopping, pulverization, powderization or any other process that alters the shape, size and/or consistency of the plant-based material, and (3) byproducts of various processes used to process plant-based material, wherein the byproduct generally includes some amount of solid plant-based material having oil adhered thereto.

General classes of plant-based material from which oil can be extracted, separated and/or removed via the methods and systems described herein include, but are not limited to, grains, nuts, seeds, fruits, vegetables, flowers, and any other type of plant material. Exemplary, though non-limiting, examples of specific plant-based materials from which oil can be extracted, removed and/or separated via the methods and systems described herein include Barley, Camelina, Flax seed, Mustard seed, Olive seed, Peanuts, Pennycress, Rapeseed, Wheat Germ, Almond, Argan, Borage, Castor, Cherry, Cherry pit, Coconut, Corn, Soybean, Cottonseed, Linseed, Grape, Grape seed, Hemp, Jojoba, Macadamia nut, Mango, Neem, Palm kernel, Canola, Safflower, Sesame, Sunflower, Tonka bean, Tung, Amaranth, False flax, Quinoa, Rice, Rice bran, Brazil nut, Cashew, Marula, Mongongo, Pecan, Pine nut, Pistachio, Walnut, Beech nut, Hazelnut, Pumpkin seed, Grapefruit, Grapefruit seed, Lemon, Lemon seed, Orange, Orange seed, Bitter gourd, Bottle gourd, Buffalo gourd, Butternut squash, Butternut squash seed, Egusi seed, Watermelon seed, Apricot, Apple seed, Argan, Avocado, Babassu, Ben, Borneo tallow nut, Cape chestnut, Carob pod, Cocoa, Cocklebur, Cohune, Coriander seed, Date seed, Dika, Kapok seed, Kenaf seed, Lallemantia, Mafura, Meadowfoam seed, Niger seed, Poppy seed, Nutmeg, Okra seed, Papaya seed, Perilla seed, Persimmon seed, Pequi, Pili nut, Pomegranate seed, Pracaxi, Virgin pracaxi, Prune kernel, Ramtil, Royle, Shea nut, Sacha inchi, Sapote, Seje, Taramira, Tea seed (Camellia), Thistle, Tigernut (or nut-sedge), Tobacco seed, Tomato seed, Amur cork tree fruit, Artichoke, Astrocaryum murumuru, Balanos, Bladderpod, Brucea javanica, Burdock (Bur), Buriti, Candlenut, Carrot seed, Chaulmoogra, Crambe, Croton (tiglium), Cuphea, Cupuaçu, Honesty, Illipe, Mowrah, Neem, Ojon, Passiflora edulis, Passion fruit, Rose hip seed, Rubber seed, Sea buckthorn, Sea rocket seed, Snowball seed, Tall, Tamanu (foraha), Tonka bean (Cumaru), Tucuma, Ucuhuba seed, Colza, Radish, Salicornia, Copaiba, Jatropha, Milk bush, Nahor, Paradise, Petroleum nut, Pongamia, Alfalfa, Allspice, Ambrette seed, Angelica root, Angelica seed, Angelica stem, Angostura (cusparia bark), Anise, Asafetida, Balm (lemon balm), Balsam of Peru, Basil, Bay leaves, Bay (myrcia), Bergamot (bergamot orange), Bitter almond, Bois de rose, Cacao (Theobroma cacao L.), Chamomile (chamomile) flowers, Cananga, Capsicum, Caraway, Cardamom seed (cardamon), Carob bean, Carrot, Cascarilla bark, Cassia bark (Chinese), Cassia bark (Padang or Batavia), Cassia bark (Saigon), Celery seed, Chervil, Chicory, Cinnamon bark, Cinnamon leaf, Citronella, Citrus peels, Clary (clary sage), Clover, Coca (decocainized), Coffee, Cola nut, Coriander, Cumin (cumin), Curacao orange peel (orange, bitter peel), Cusparia bark, Dandelion, Dandelion root, Dog grass, Elder flowers, Estragole (esdragol, esdragon, tarragon), Estragon (tarragon), Fennel (sweet), Fenugreek, Galanga (galangal), Geranium, Ginger, Grapefruit, Guava, Hickory bark, Horehound (hoarhound), Hops, Horsemint, Hyssop, Immortelle, Jasmine, Juniper (berries), Kola nut, Laurel berries, Laurel leaves, Lavender, Lavandin, Lemon, Lemon balm, Lemongrass, Lemon peel, Lime, Linden flowers, Locust bean, Lupulin, Mace, Mandarin, Marjoram (sweet), Yerba Mate, Melissa, Menthol, Menthyl acetate, Molasses (extract), Naringin, Neroli, Nutmeg, Onion, Orange, Origanum, Palmarosa, Paprika, Parsley, Pepper, Peppermint, Peruvian balsam, Petitgrain, Petitgrain lemon, Petitgrain mandarin or tangerine, Pimenta, Pimenta leaf, Pipsissewa leaves, Pomegranate, Prickly ash bark, Rose absolute, Rose buds, Rose flowers, Rose fruit, Rose geranium, Rose leaves, Rosemary, Saffron, Sage, Sage (Greek), Sage (Spanish), St. John's bread, Savory (summer), Savory (winter), Schinus mole, Sloe berries (blackthorn berries), Spearmint, Spike lavender, Tamarind, Tangerine, Tarragon, Tea, Thyme, Triticum, Tuberose, Turmeric, Vanilla, Violet flowers, Violet leaves, Wild cherry bark, Ylang-ylang, and Zedoary bark.

The plant-based material, including any example from the above list, can be in whole form or modified in any suitable manner prior to or during extraction/separation of oil therefrom via the methods and systems described herein. For example, the plant-based material may be cut, chopped, sliced, crushed, powderized, or any other manner of altering the size, shape, and/or consistency of the material. The plant-based material may also be subjected to various processing steps before or during oil extraction that improves the condition of the plant material for oil extraction. For example, parts or sections of the plant material may be removed, such as a shell, husk, leaves, stems, etc., in order to expose a portion of the plant-based material that is better suited for oil extraction or otherwise better prepare the plant-based material for oil-extraction.

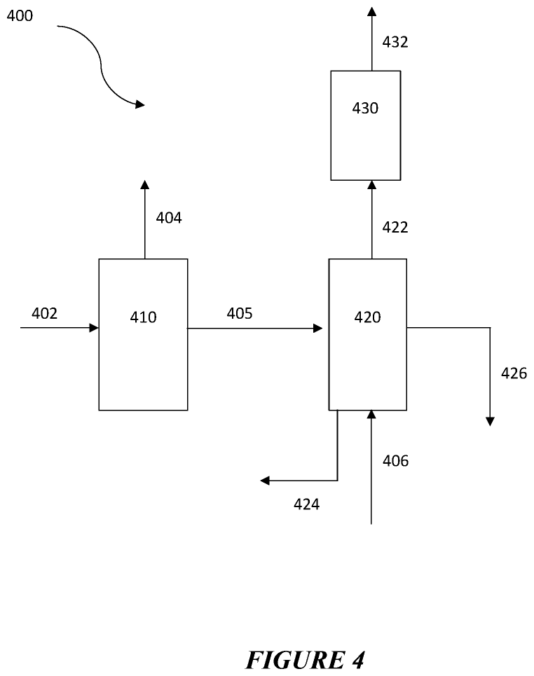

As noted previously, the plant-based material subjected to oil extraction/separation by the methods and systems described herein may also be subjected to various processes prior to oil extraction, and the oil extraction may be carried out on a byproduct of such processes. The byproduct will generally include some component of the plant-based material, but may be mixed with other materials used in the prior processing of the plant-based material. In one example, the oil extraction systems and method described herein are used on a byproduct of the process of producing ethanol from corn. As described in greater detail below with respect to FIG. 4, the process of producing ethanol from corn results in the creation of whole stillage. The whole stillage generally includes corn particulate, water, alcohol, oil, and other components such as glycerol, acetic acid, yeast, and/or other alcohol producing microorganism. As such, the systems and methods described herein can be used on the stillage (or a separated stream formed therefrom when the stillage is subjected to, e.g., centrifugation, stacked plate separation, or any other applicable separation mechanism in order to extract/separate an oil component from the stillage.

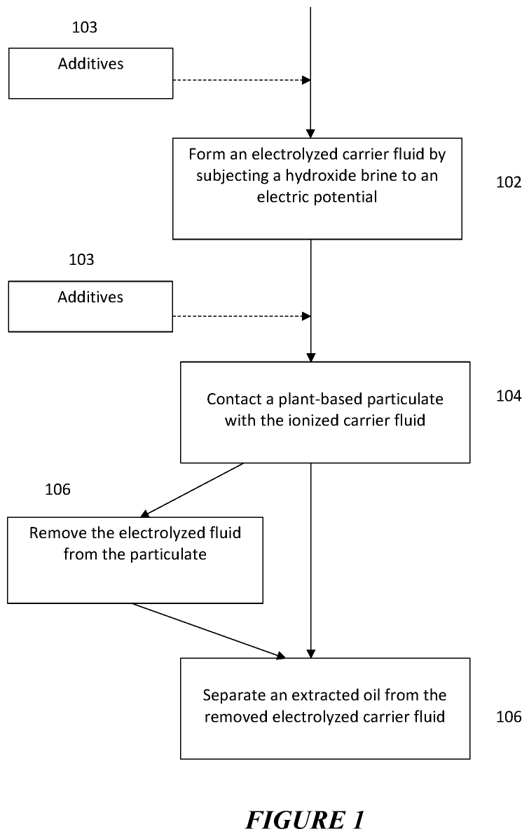

With reference now to FIG. 1, a general process 100 for extracting oil from a plant-based material is shown. The process 100 generally includes a step 102 of providing an electrolyzed carrier fluid having a negative potential, a step 104 of contacting a plant-based material with the electrolyzed carrier fluid, an optional step 106 of separating the electrolyzed carrier fluid from the plant-based material (the electrolyzed carrier fluid now having oil extracted from the plant-based material contained therein), and a step 108 of separating the extracted oil from either the electrolyzed carrier fluid (in embodiments where step 106 is carried out) or from the mixture of electrolyzed carrier fluid and the plant-based material (in embodiments where step 106 is not caned out). Process 100 may also include an optional step 103 of mixing various additives with the carrier fluid prior to step 102 and/or prior to step 104.

In step 102 of process 100, an electrolyzed carrier fluid having a negative potential is provided. As discussed in greater detail below with respect to step 104, an aim of the electrolyzed carrier fluid is to facilitate the separation of oil from solid plant-based material. To accomplish this, the electrolyzed carrier fluid is configured to act on the electrochemical charge balance between a solid-liquid interface (e.g., the interface between the oil and the solid plant-based material) to reversibly alter the electrochemical Zeta potential and overcome the technical impediments to efficiently increase oil separation from the solids. For example, the electrolytic carrier fluid is capable of impacting bonding potential between oil and solid to thereby release the oil from the solid and thus allow for improved recovery. The electrolyzed carrier fluid may also alter the electrochemical state of the oil(s) for improved recovery. The electrolytic carrier fluid directly modifies the electrochemical properties at the point of oil-particulate contact, satisfying the electrostatic attraction at the boundary and allowing release of the oil from the particulate. This thereby increases recovery of oil(s), other fats, and oleic materials and increases the extraction efficiency by modifying the electrochemical charge that traps the oil adhering to the solids. The electric potential (typically measured in millivolts (mV)) varies from each type of material to be extracted and/or from previous processing steps.

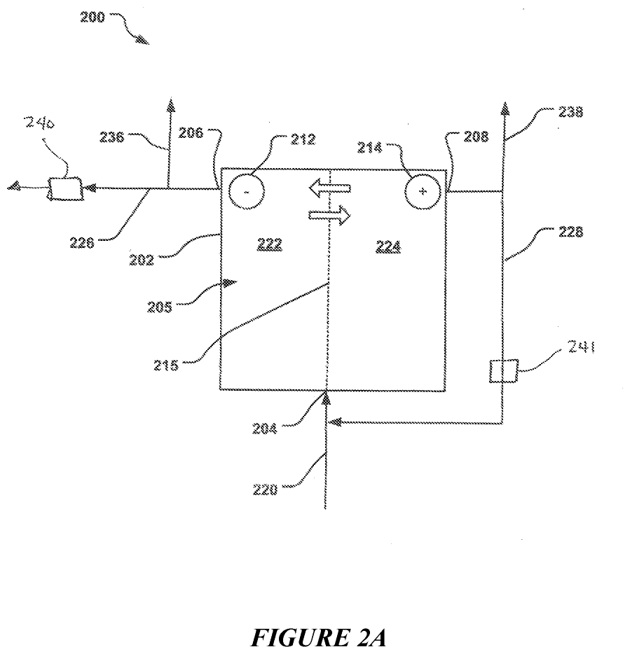

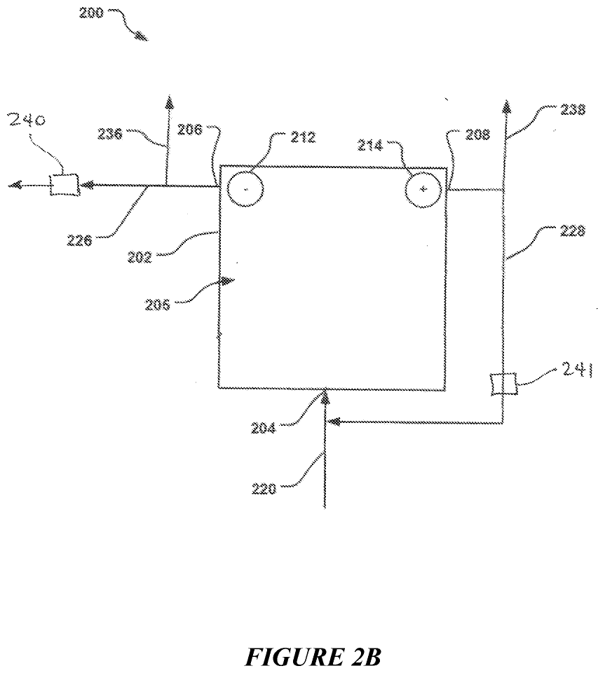

In order to provide the electrolyzed carrier fluid capable of facilitating the separation of oil from solid plant-based material in the manner described above, a fluid electrolyzer may be used to create the electrolyzed carrier fluid. With reference to FIGS. 2A and 2B, two embodiments of a fluid electrolyzer suitable for use in providing the electrolyzed carrier fluid of step 102 is illustrated. As described in more detail below, the fluid electrolyzer generates the electrolyzed carrier fluid and controls the electrical potential of the fluid by adjusting current density, which can be impacted by the total dissolved solids in the fluid, plate size and type, membrane type, voltage, fluid residence time, or a combination of these variables. This allows tailoring the carrier fluid potential to maximize the extraction efficiency of the target component within a lower operating cost structure. The fluid electrolyzer can also adjust and control the pH of the carrier fluid to improve efficiency of the extraction process. With an increase of the reducing potential used, typically the greater the pH of the carrier fluid.

FIGS. 2A and 2B schematically show different embodiments of a fluid electrolyzation unit 200A, 200B for the production of an electrolyzed carrier fluid, suitable for extracting/separating/removing oil from the plant-based solids components. Fluid electrolyzation unit 200A is substantially identical to fluid electrolyzation unit 200B save for the absence of a membrane 215 in fluid electrolyzation unit 200B.

The electrolyzation unit 200 includes a vessel 202 for receiving and temporarily retaining a fluid (e.g., a liquid) therein. The vessel 202 has a fluid inlet 204 and a first fluid outlet 206 and a second fluid outlet 208, all fluidly connected to an interior 205 of the vessel 202. For simplicity, the below discussion focuses primarily on the electrolyzation unit 200A, but the below description largely also applies to electrolyzation unit 200B

The electrolyzation unit 200A has at least one pair, typically a plurality or series of pairs, of simple electrodes, one pair shown in FIG. 2 as a cathode 212 and an anode 214. The cathode 212 and the anode 214 may be made from any material that meets the desired application, such as titanium, graphite, platinum, stainless steel, iridium and the like. An electrical potential is present at the cathode 212 and the anode 214, provided by appropriate wiring, not shown in FIG. 2. The potential applied is sufficient to raise the reductive oxidation-reduction-potential (ORP) to −700 mV or more, such as in the range of from about −900 mV to about −1000 mV.

With respect to electrolyzation unit 200A shown in FIG. 2A, each pair of the cathode 212 and the anode 214 is separated by a permeable membrane 215 that is ion and electron permeable. Any membrane material capable of transferring ions across the membrane can be used for the membrane 215. The membrane 215 can be made from a wide range of materials, including as simple as cotton fibers, or as complex as various chloro-fluoro carbon fibers; a traditional ion exchange membrane is a suitable membrane.

The membrane 215 divides the interior 205 into a first portion or channel 222 between the membrane 215 and the cathode 212 and a second portion or channel 224 between the membrane 215 and the anode 214. The first channel 222 is fluidly connected to the outlet 206 and the second channel 224 is fluidly connected to the outlet 208.

With reference to FIG. 2B, the electrolyzation unit 200B does not include a membrane 215, and as such, the electrolyzation unit 200B is not divided in to a first and second portion. Regardless of the absence of the membrane 215 in unit 200B, the unit 200B still effectively operates to create the electrolyzed carrier fluid as discussed in greater detail below.

The electrolyzation unit 200 includes appropriate piping 220 connected to the inlet 204 to provide a hydroxide brine to the interior 205. The hydroxide component of the hydroxide brine may be, e.g., NaOH or KOH. The hydroxide concentration of the brine may be less than 3 wt-%, such as in the range of from about 0.5 to about 3 wt-%. In some implementations, the hydroxide brine is a monovalent hydroxide brine. In some embodiments, the pH of the initial hydroxide brine fed into the unit 200 is about 12.4.

As discussed in greater detail below with respect to step 103, various forms of silica can be added to the hydroxide brine prior to feeding the hydroxide brine into the electrolyzation unit to create the electrolyzed carrier fluid. Addition of silica in this manner allows the hydroxide brine to carry additional reductive charge and act as a demulsifier in the process.

Because the technology described herein generally relates to the treatment of plant-based materials, such as vegetables, that may be later used for human or animal consumption/contact, it is important that the hydroxide brine used in the creation of the electrolyzed fluid be substantially (e.g., <200 ppm) or preferably completely free of halogens. If halogens are present in the hydroxide brine, they may be released due to conversion of halogen-containing compounds during the process of creating the electrolyzed fluid. The presence of halogens in the electrolyzed fluid as the result of using a brine solution having a halogen-containing component when producing the electrolyzed fluid will generally frustrate a primary purpose of the technology disclosed herein, since the presence of the halogen may ultimately make any plant-based material treated with the electrolyzed brine to separate oil therefrom unsuitable for human/animal consumption/contact. As such, salt brines based on, e.g., NaCl, or brines with an elevated NaCl contaminate are not suitable for use in the technology described herein.

With respect to FIG. 2A, the brine flows into the interior 205 into both channels 222, 224. As the brine flows from the inlet 204 to the outlets 206, 208 in the channels 224, 226, it is electrolyzed by the charges on the cathode 212 and the anode 214, and is then separated by the permeable membrane 215 based on the resulting electrolyzation, as described in detail below. With respect to FIG. 2B, the brine flows into the entire interior 205 and is electrolyzed by the charges on the cathode 212 and the anode 214. Because the unit 200B of FIG. 2B does not include the membrane 215, there may be less separation of reduced and oxidized components, but primarily reduced electrolyzed carrier fluid will exit out of outlet 206 closet to the cathode 212, just as partially oxidized electrolyzed carrier fluid will exit out of outlet 208 closest to the anode 214.

The hydroxide brine acts as the conducting medium between the cathode 212 and the anode 214. The charge across the cathode 212 and the anode 214 causes anions to be attracted to anode 214 and cations to be attracted to the cathode 212. Thus, the brine is oxidized at the anode 214 to form an oxidized electrolyzed fluid and is reduced at the cathode 212 to form a reduced electrolyzed fluid. Some of the variables that control the magnitude of the electrolytic process are the flow rate of the brine and the carrier fluid through the vessel 202, the charge potential between the anode 214 and cathode 212, the fluid residence time in the vessel 202, and the amperage used to electrolyze the fluid.

The (reduced) electrolyzed carrier fluid is discharged from vessel 202 via the outlet 206 and the (oxidized) electrolyzed carrier fluid is discharged from the vessel 202 via the outlet 208. If multiple pairs of anodes/cathodes and membranes are present, all of the (reduced) electrolyzed carrier fluid may be combined prior to flowing out of the vessel 202 via the outlet 206 and piping 226; similarly, all of the (oxidized) electrolyzed carrier fluid may be combined prior to flowing out of the vessel 202 via the outlet 208 and piping 228.

The two electrolyzed fluid streams have a charge difference related to the dissolved constituents in the carrier fluid, current density across the cathode 212 and the anode 214, residence time in the ionization unit 200, and other secondary factors. The residence time in the presence of a charge allows the carrier fluid and its dissolved solids to disassociate and the anions and cations to pass through the permeable membrane 215 (in unit 200A), thus separating the dissolved solids. The size, power requirements, and detailed configuration of the ionization unit 200 and permeable membrane 215 (if used) are dictated by the field specific requirements/applications.

The electrolyzed carrier fluid from the outlet 206 and the piping 226 is an aqueous hydroxide solution (e.g., NaOH, at about 0.05 to 10 wt-%) with negative or reducing potential (excess of electrons) that can be adjusted to control the recovery of the oil from the stillage. Typically, the potential is in the range of −500 mV to −1100 mV. In some preferred embodiments, the potential is in the range of from −700 mV to −1,000 mV, or in a range of from about −900 to about −1,000 mV. The amount of oil present in the material to be treated may affect the desired potential, as may the size of the particulate or the dilution allowed in a given process. If silica compounds are included in the electrolyzed carrier fluid, they may be present in a range of from about 10 ppm to about 1 wt-%.

The electrolyzed carrier fluid from the outlet 206 and the piping 226 is basic or caustic, having a pH of greater than about 12.

The reduced electrolyzed carrier fluid stream, from the cathode 212, may include a gaseous component such as H₂, which can be off-gassed from the piping 226 via a vent 236. This gaseous component can be merely vented or can be collected and subsequently used. Furthermore, as shown in FIGS. 2A and 2B, a granular activated carbon (GAC) unit 240 may be provided such that the reduced electrolyzed carrier fluid may be treated to remove any residual undesirable chemicals that may be present in the reduced electrolyzed carrier fluid. The GAC unit 240 may specifically be used to target and remove any halogen components from the reduced electrolyzed carrier fluid stream.

The oxidized electrolyzed carrier fluid stream may include a gaseous component such as O₂ and O₃, which can be off-gassed from the piping 228 via a vent 238. This gaseous component can be merely vented or can be collected and subsequently used. Furthermore, as shown in FIGS. 2A and 2B, a granular activated carbon (GAC) until 241 may be provided such that the oxidized electrolyzed carrier fluid may be treated to remove any undesirable chemicals that may be present in the oxidized electrolyzed carrier fluid. The GAC unit 241 may specifically be used to target and remove any halogen components from the oxidized electrolyzed carrier fluid stream.

For the separation of and extraction of oil from plant-based material, the reduced electrolyzed carrier fluid in the piping 226 may be fed to unit for contacting plant-based material with the reduced electrolyzed carrier fluid, as described below. The piping 226 can be in fluid communication with a mixing vessel or other mixing equipment capable of receiving the electrolyzed fluid and the plant-based material. The piping 226 may also be fluidly connected with a storage vessel such that the reduced electrolyzed fluid may be stored for a period of time prior to being mixed with plant-based material.

The oxidized electrolyzed carrier fluid in the piping 228, which may include trace contaminants such as Cl₂, HOCl and/or NaOCl (if NaOH brine was the input) and H₂O₂, can be recycled and combined with fresh hydroxide brine at the inlet 204. These and any other contaminants may be removed or neutralized, if desired for the purpose of minimizing any typical waste stream, such as through the use of previously described GAC unit 241. In other implementations, the oxidized electrolyzed carrier fluid in the piping 228 may not be recycled, but used for a different process, or discarded.

In one particular example, when NaOH hydroxide brine at 0.5 to 3 wt-% is used as the input, a NaOH electrolyzed carrier fluid, having a pH in the range of 12.9 to 13.3 and a potential of −900 mV to −1000 mV, is obtained.

Not shown in FIG. 2, but operably connected to the electrolyzation unit, may be various fluid processing equipment, such as a pump or pumping station that pumps the brine to the unit 200, and a carrier fluid storage tank to retain the (reduced) electrolyzed carrier fluid. The brine may be filtered to remove any large pieces of solids or debris to prevent damage to the electrolyzation unit 200. Similarly, the electrolyzed carrier fluid may be filtered. Any number of pumps, filters, pipes, valves, storage tanks, etc. may be used to achieve the desired operation.

Additional features and details applicable to the unit 200 can be found in U.S. Pat. No. 8,157,981 (Peters et al.), U.S. Pat. No. 8,333,883 (Peters et al.), U.S. Pat. No. 8,394,253 (Peters et al.), U.S. Pat. No. 9,445,602 (Peters et al.), and U.S. Pat. No. 10,676,663 (Breedlove et al.), the disclosures of all of which are incorporated herein by reference for all purposes.

Further, although the electrolyzation unit 200 and the electrolyzation process of the hydroxide brine (to form the carrier fluid) is described as a continuous process herein, the process may alternately be done as a batch process. For example, a basic electrolyzer may be constructed by using simple vessels (like tanks or barrels) with an electrode (cathode or anode) in each vessel and linked with a pipe separated by a membrane. In this batch approach, a flowing fluid may not be necessary.

Referring back to FIG. 1, having thus provided the electrolyzed carrier fluid in step 102 using, e.g., the electrolyzation unit 200 described previously, the method 100 may proceed to step 104 wherein plant-based material is contacted with the electrolyzed carrier fluid. The specific type of plant-based material contacted with electrolyzed fluid in step 104 is generally not limited provided the plant-based material has some component of oil that is to be extracted or separated from the plant-based material. As described in greater detail previously, the plant-based material can be in the form of whole plant material, comminuted plant-based material, or a composition containing plant-based material (such as that produced as a byproduct of other processing carried out on the plant-based material).

Any manner of contacting the plant-based material with the electrolyzed fluid can be used in step 104 provided that the contacting method allows for the electrolyzed fluid to impact the solid-liquid interface between the solid plant-based material and the oil and thereby help separate oil from the plant-based material. In some embodiments, the electrolyzed fluid is sprayed down on or up through the plant-based material. In some embodiments, the plant-based material is drawn through a bath of electrolyzed fluid. The electrolyzed carrier fluid may be sprayed or dripped onto the plant-based material (e.g., in a vessel) and allowed to flow through (e.g., downward through) the plant-based material and leach the oil from the plant-based material without physical mixing or agitation. Alternately, the electrolyzed carrier fluid can be bubbled up into the plant-based material and allowed to flow through (e.g., radially, downward through) the plant-based material and leach the oil from the plant-based material.

In some embodiments, the electrolyzed fluid contacts the plant-based material by combining the electrolyzed fluid with other extraction processes. For example, previously known oil extraction techniques used for extracting oil from plant-based material includes mechanical pressing and solvent extraction. With respect to mechanical pressing, the electrolyzed fluid can be applied to the plant-based material prior, during and/or after any type of mechanical pressing to further promote the separation of oil from the solid material. With respect to solvent extraction, the electrolyzed fluid can be applied to the plant-based material before or after solvent extraction, or may be mixed with the solvent to aid separation of oil from solid material during the solvent extraction process.

Regardless of the specific method of contacting the plant-based material with the electrolytic carrier fluid, the contacting step 104 can be carried out as a continuous process or a batch process.

The amount of electrolyzed carrier fluid added to the plant-based material in step 104 is generally not limited. In some embodiments, the amount of electrolyzed fluid used is based on the amount of oil extraction desired. In some embodiments where the plant-based material is to be immersed in the electrolyzed fluid, the amount of electrolyzed fluid used is sufficient to form a slurry, e.g., a pumpable slurry or a readily mixable slurry. Generally speaking, the amount of oil extraction increases with the amount of contact of the electrolyzed fluid with the solid material, due to the electrolyzed carrier fluid altering the potential and the Zeta potential at the solid-liquid interface and hence releasing the oil.

Examples of suitable equipment for combining the electrolyzed fluid and the solids include vessels, tanks, augers, high speed mixers, high shear mixers, tumblers, grinders, etc.

Prior to step 102 and/or between step 102 and step 104 of method 100, an optional step 103 can be performed, optional step 103 generally including adding one or more additives to the hydroxide brine or electrolyzed fluid prior to contacting the plant-based material with the electrolyzed fluid. Additives such as various types of FDA GRAS (Generally Regarded as Safe)-approved silica, emulsifiers, demulsifiers, specific polymers, sorbates, polysorbates, food grade solvents or other materials such as food grade wetting agents/surfactants may be added to the hydroxide brine or carrier fluid to enhance the ability of the carrier fluid to release and carry a charge and/or to enhance the ability of the carrier fluid to release and carry or aggregate the recovered oil. Exemplary but not limiting silicon materials that maybe added to the hydroxide brine and/or carrier fluid as part of step 103 include natural or synthetic amorphous silicas, colloidal, fumed, or other silicas/mixtures capable of carrying a charge.

As a result of contacting the plant-based material with the electrolyzed fluid in step 104, an oil component of the plant-based material is separated from the plant-based material. More specifically, the oil is separated from the plant-based material and becomes entrained in the electrolyzed fluid. Thus, following step 104, a mixture of the electrolyzed fluid and the separated oil is formed. Any amount of oil can be entrained in the electrolyzed fluid, with the quantity of oil generally depending on how much oil was separated from the plant-based material as a result of the contacting step 104.

In light of step 104 producing a mixture of electrolyzed fluid and extracted oil, method 100 can further include an optional step 106 of separating the mixture of electrolyzed fluid and extracted oil from the plant-based material. Any manner of performing this separation can be used. In some embodiments where the electrolyzed fluid is sprayed on to the plant-based material, or where the plant-based material is drawn through a bath of the electrolyzed fluid, the separation step 106 may largely be carried out inherently by virtue of the contacting method. For example, when electrolyzed fluid is sprayed down on plant-based material, the electrolyzed having oil contained therein may separate from the plant material based on the electrolyzed fluid passing down and through the plant material under the power of gravity. However, to the extent that electrolyzed fluid remains with the plant-based material after contacting step 104, any additional separation techniques can be used to separate the electrolyzed fluid (having oil entrained therein) from the plant-based material as part of optional step 106.

To the extent that the contacting step 104 does not result in inherent separation of the electrolyzed fluid from the plant-based material, any suitable separation techniques known for separating liquids from solids can be used to separate the mixture of electrolyzed fluid and oil from the plant-based material as part of optional step 106. Non-limiting examples of such separation techniques may include draining, pressing, centrifuging, filtering, etc.

When step 106 is carried out as part of method 100, separation step 106 generally results in the formation of a mixture of the electrolyzed fluid and separated oil. In step 108 of method 100, the oil component of this mixture of carrier fluid and oil is separated from the mixture. Generally speaking, the mixture may largely include a water component (from the original brine solution) and the oil component. Because the oil is generally immiscible in the water component of the mixture, the oil can be readily separated from the mixture by various techniques as part of step 108. Non-limiting examples, include gravity separation, centrifuging, distillation, or evaporation.

Alternatively, in embodiments where step 106 is not carried out as part of method 100, method 100 can proceed from step 104 (where the electrolyzed carrier fluid is contacted with the plant-based particulate material to form a mixture of plant-based material and the electrolyzed fluid) to step 108, wherein the oil component is separated from the mixture of plant-based material and electrolyzed carrier fluid. Generally speaking, this mixture of carrier fluid and plant-based particulate may largely include a water component (from the original brine solution) and the oil component. Because the oil is generally immiscible in the water component of the mixture, the oil can be readily separated from the mixture by various techniques as part of step 108. Non-limiting examples, include gravity separation, centrifuging, distillation, or evaporation. In embodiments where additives are included in the electrolyzed carrier fluid, the additives help the oil to separate from the plant-based particulate and can then be recovered from the mixture of particulate and carrier fluid by any suitable separation techniques, including the mechanical separation techniques as described previously.

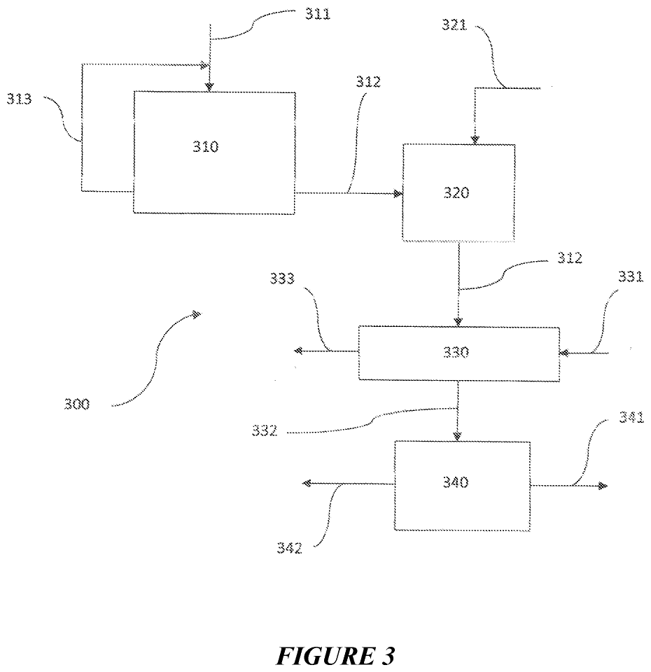

With reference now to FIG. 3, a system 300 generally configured to carry out the method 100 (including optional step 106) described above is shown. The system 300 generally includes an electrolyzation unit 310, an (optional) additive mixing vessel 320, a contacting vessel 330, and a separation vessel 340. It should be appreciated that system 300 can be modified to carry out method 100 where optional step 106 is not carried out. More specifically, system 300 is modified to eliminate stream 333 such that all plant-based particulate, oil and electrolyzed fluid mixed together in contacting vessel 330 passes to separation vessel 340.

Electrolyzation unit 300 is generally similar or identical to the electrolyzation units 200A, 200B described previously with respect to FIGS. 2A and 2B. The electrolyzation unit 300 is generally configured to receive a hydroxide brine 311 and produce a reduced electrolyzed fluid 312 and an oxidized electrolyzed fluid 313. As shown in FIG. 3, the oxidized electrolyzed fluid is recycled back into the electrolyzation unit 300, while reduced electrolyzed carrier fluid 312 (having a potential in the range of, e.g., −900 mV to −1000 mV and a pH of around 13) is fed to optional additive mixing vessel 320.

At additive mixing vessel 320, one or more additives 321 are mixed with the reduced electrolyzed carrier fluid. As discussed in more detail previously, the additives 321 optionally added in mixing vessel 321 are designed to help improve the functionality of the electrolyzed fluid with respect to separating and/or aggregating oil from the plant-based material.

Having optional additives mixed therewith, reduced electrolyzed carrier fluid 312 exits mixing vessel 312 and is transported to contacting vessel 330. At contacting vessel 330, plant-based material 331 is contacted by the electrolyzed fluid 312 to thereby separate oil from the plant-based material. As shown in FIG. 3, contacting vessel 330 is designed as a pass-through contacting vessel where plant-based material is moved through the vessel 330 as electrolyzed fluid passes down through the plant-based material and in the process separates oil from the plant-based material. Oil-depleted plant-based material 333 passes out of the contacting vessel 330, while mixture 332 of electrolyzed fluid and oil pass down out of the contacting vessel 330. In this configuration, the contacting step and the step of separating the mixture of oil and electrolyzed fluid from the plant-based material is carried out essentially simultaneously. In other configurations, a mixture of plant-based material, electrolyzed fluid and oil is created in contacting vessel 330, in which case a further separation vessel (not shown in FIG. 3) is required to separate the mixture of oil and electrolyzed fluid from the plant-based material (such as through draining, centrifugation, filtering, etc.).

The mixture 332 of oil and electrolyzed fluid next passes to separation vessel 340, with separation vessel being designed to separate the oil component from the electrolyzed fluid. Using whatever suitable method for this separation, the separation vessel thus produces an oil stream 341 and an electrolyzed fluid stream 342.

As discussed previously, in some embodiments the plant-based material that is contacted with electrolyzed fluid according to the system and methods described herein is a composition that includes plant-based material. One example of such a composition is a composition formed as a byproduct of another process carried out on the plant-based material. This may be most commonly seen in the production of ethanol from corn or other plant-based materials (e.g., sorghum/milo, barley, wheat, soybeans, etc.), which process forms stillage containing therein plant-based material having oil adhered thereto and which can be separated from the plant-based component of the stillage using the methods and systems described herein.

In a traditional ethanol plant, corn is used as the feedstock and ethanol is produced from the starch contained within the corn. Corn kernels are cleaned and milled (e.g., ground, crushed) to prepare the material for processing. Corn kernels can also be fractionated to separate the starch-containing material (e.g., endosperm) from other matter (such as fiber and germ). The starch-containing material is combined with water to form a slurry and facilitate saccharification, where the starch is converted into sugar (e.g., glucose), and fermentation, where the sugar is converted into ethanol, e.g., by yeast. The resulting fermentation product is commonly referred to as beer, having a liquid component (including ethanol, water, and soluble components) and a solids component (including unfermented particulate matter, e.g., the remaining corn particles).

The fermentation product, or beer, is sent to a distillation system where it is distilled to obtain the ethanol. The residual matter (e.g., whole stillage) from the distillation is a combination of water, soluble aqueous components, oil, and unfermented solids (e.g., the solids component of the beer with substantially all ethanol removed). The solids are dried into dried distillers grains (DDG) (also known as DDGS—dried distillers grains with solubles) and sold, for example, as an animal feed product. Other co-products (e.g., oil, syrup), can also be recovered from the whole or thin stillage. Water removed from the fermentation product in distillation can be treated for re-use at the plant.

FIG. 4 schematically shows a traditional process 400 for the production of ethanol from corn, which can be characterized as either a dry mill process or as a wet mill process. The process 400 includes a beer well 410 and a distillation system 420. In general, the beer well 410 receives a beer supply 402 from a fermenter or a plurality of fermenters. The beer 402 has a liquid component (including ethanol, water, and soluble components) and a solids component, (including unfermented particulate matter, e.g., the remaining corn kernels). Commercial ethanol producing facilities typically provide the beer 402 from a batch process, thus collecting the beer 402 in the beer well 410 allows for the downstream processing of the beer to be provided in a relatively continuous manner. Although the downstream processing is described as continuous, it should be understood that the downstream processing can be provided as a batch process. The beer well 410 can include a relief stream 404 for the removal of, e.g., carbon dioxide; it is fairly common for the beer 402 to give off carbon dioxide in the beer well 410 even though the beer 402 has left the fermenters. Beer exists the beer well 410 as a beer stream 405.

The distillation system 420 is shown diagrammatically and can be provided, for example, as a single distillation column or as a series of distillation columns arranged in parallel or in series. The energy for driving the distillation process can be provided in a number of ways; for the distillation system 420, heat to the distillation system 420 is provided by water vapor 406 (e.g., steam).

In general, the beer 405 flows from the beer well 410 to the distillation system 420 where the beer 405 is separated into a volatile fraction 422, a bottoms fraction 424, and an intermediate fraction 426, which are not necessarily pure. In general, the volatile fraction 422 includes alcohol and water, the bottoms fraction 424 includes whole stillage, and the intermediate fraction 426 includes predominantly water. The whole stillage is generally a combination of water, soluble aqueous components, oil, and unfermented solids (e.g., the solids component of the beer with substantially all ethanol removed).

The volatile fraction 422 generally includes alcohol and water, which can be processed through a screening process 430 for the separation of alcohol from the water, and the resulting purified alcohol 432 can be recovered.

The bottoms fraction 424 is the whole stillage, which includes a concentration of the particulates from the beer stream 402, 405. In addition to the particulates, the stillage can include water, alcohol, oil, and other components such as glycerol and acetic acid, yeast, or other alcohol producing microorganism. The whole stillage can be separated (e.g., centrifuged) into at least two streams. One stream can include the relatively light components such as, for example, water, glycerol, and acetic acid, and can be treated and either discarded or recycled. The other stream typically includes the particulates and the oil, because the oil typically remains bound or otherwise adhered to the particulates. The oil in this fraction can be of value if separated from the particulates. The particulates are eventually dried (into DDG or DDGS) and sold, for example, as an animal feed product.

### EXAMPLES

### Example 1: Oil Extraction from Corn Fluid

Samples of corn fluid (942 g each) having an initial pH of 2.52 and an ORP of +418 mV were provided for determining the effect of an electrolyzed fluid prepared in accordance with embodiments described herein on oil extraction from the corn fluid sample.

Control: Process additives without any electrolyzed fluid were used on the corn fluid sample as described above to serve as a control. The process additives were Polysorbate 20 with fumed silica. The additives were tested by adding a predetermined dose of the additives to 942 g of corn fluid at −80° C., then briefly mixing. A 100 mL sample was transferred to a centrifuge tube and was then centrifuged for 30 minutes in order to separate the free oil from the rest of the particulates and water. The amount of oil was determined by measuring the weight of the free oil upon decant from the water layer in the centrifuge tube. The resulting decanted oil weighed 7.86 g showing a recovery percentage of 1.8%. The addition of the additives also showed no available shift in the ORP or the pH of the corn fluid.

Test 1: Process additives with an electrolyzed fluid were used on the corn fluid sample as described above to determine the effect of the electrolyzed fluid on oil extraction from the corn fluid sample. The process additives were Polysorbate 20 and fumed silica. The electrolyzed fluid was a hydroxide solution having a negative ORP. The combination of additives and electrolyzed fluid were tested by adding a predetermined dose of the combination to 942 g of corn syrup at −80° C. then briefly mixing. A 100 mL sample was transferred to a centrifuge tube and was then centrifuged for 30 minutes in order to separate the free oil from the rest of the particulates and water. The amount of oil was determined by measuring the weight of the free oil upon decant from the water layer in the centrifuge tube. The resulting decanted oil weighed 10.69 g showing a recovery percentage of 2.4%. The addition also showed a significant shift of ORP of the corn fluid from +418 mV before the addition of the additives and electrolyzed fluid to −428 mV after addition. The pH value of the corn fluid showed a significant increase as well from 2.52 in the initial corn fluid to 6.91 after addition. Table 1 below provides a summary of the Control and Test 1 described above.

TABLE 1

| | Control | Test 1 |
|---|---|---|
| Weight of Corn Fluid (g) | 942 | 942 |
| Initial pH | 2.52 | 2.52 |
| Final pH | — | 6.91 |
| Initial ORP (mV) | +418 | +418 |
| Final ORP (mV) | — | −428 |
| Recovery Weight (Oil) (g) | 7.86 | 10.69 |
| Recovery Percentage (%) (Oil) | 1.8 | 2.4 |

### Example 2: Oil Extraction from Corn Fluid

Samples of corn fluid (500 g each) having an initial pH of 4.54 and an ORP of +35 mV were provided for determining the effect of a negative ORP electrolyzed fluid prepared in accordance with embodiments described herein on oil extraction from the corn fluid sample.

Control: Process additives without any electrolyzed fluid were used on the corn fluid sample as described above to serve as a control. The process additives were Polysorbate 20 with fumed silica. The additives were tested by adding a predetermined dose of the additives to 500 g of corn fluid at −80° C., then briefly mixing. A 100 mL sample was transferred to a centrifuge tube and was then centrifuged for 30 minutes in order to separate the free oil from the rest of the particulates and water. The amount of oil was determined by measuring the weight of the free oil upon decant from the water layer in the centrifuge tube. The resulting decanted oil weighed 19.52 g showing a recovery percentage of 3.09%. The addition of the additives also showed no available shift in the ORP or the pH of the corn fluid.

Test 2: Process additives with a negative ORP electrolyzed fluid were used on the corn fluid sample as described above to determine the effect of the electrolyzed fluid on oil extraction from the corn fluid sample. The process additives were Polysorbate 20 and fumed silica. The electrolyzed fluid was a hydroxide solution having a negative ORP. The combination of additives and electrolyzed fluid were tested by adding a predetermined dose of the combination to 500 g of corn syrup at −80° C. then briefly mixing. A 100 mL sample was transferred to a centrifuge tube and was then centrifuged for 30 minutes in order to separate the free oil from the rest of the particulates and water. The amount of oil was determined by measuring the weight of the free oil upon decant from the water layer in the centrifuge tube. The resulting decanted oil weighed 21.07 g showing a recovery percentage of 4.215%. The addition also showed a significant shift of ORP of the corn fluid from +35 mV before the addition of the additives and electrolyzed fluid to −207 mV after addition. The pH value of the corn fluid showed a significant increase as well from 4.54 in the initial corn fluid to 5.17 after addition. Table 2 below provides a summary of the Control and Test 2 described above.

TABLE 2

| | Control | Test 2 |
|---|---|---|
| Weight of Corn Fluid (g) | 500 | 500 |
| Initial pH | 4.54 | 4.54 |
| Final pH | — | 5.17 |
| Initial ORP (mV) | +35 | +35 |
| Final ORP (mV) | — | −207 |
| Recovery Weight (Oil) (g) | 19.52 | 21.075 |
| Recovery Percentage (Oil) | 3.09 | 4.215 |

### Example 3: Effect of Electrolyzed Fluid on FFA Content

One of the concerns when improving oil recovery or modifying any of the system processes is the potential impact to Free Fatty Acid (FFA) content, as the regulatory limit for FFA is 15%.

Samples of treated corn syrup were taken after treatment and oil extraction with the herein described technology, along with a control sample of the untreated syrup, and analyzed for FFA concentrations. The results below show a small decrease in the FFA concentration after treatment as compared to the control sample.

Control sample (untreated)=13.54% FFA
Sample 1, 3% brine treated=10.72% FFA
Sample 2, 6% brine treated=11.56% FFA

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “approximately”. At the very least, and not as an attempt to limit the application of the doctrine of equivalents to the claims, each numerical parameter recited in the specification or claims which is modified by the term “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

I/We claim:

1. A method of extracting oil from a plant-based material, the method comprising:
contacting the material with an electrolyzed carrier fluid having a reductive potential;
removing the electrolyzed carrier fluid from the particulate; and
separating an extracted oil from the removed electrolyzed carrier fluid.

2. The method of claim 1, wherein the step of contacting the material comprises wetting the surface of the material.

3. The method of claim 1, wherein contacting the material comprises forming a slurry of the material and the electrolyzed carrier fluid.

4. The method of claim 1, wherein the electrolyzed carrier fluid has a reductive potential of −700 mV to −1000 mV.

5. The method of claim 1, wherein the electrolyzed carrier fluid has a pH greater than about 12.

6. The method of claim 1, wherein the plant-based material is stillage.

7. The method of claim 1, wherein the electrolyzed carrier fluid comprises hydroxide.

8. The method of claim 7, wherein the electrolyzed carrier fluid comprises NaOH or KOH.

9. The method of claim 7, wherein the electrolyzed carrier fluid is substantially free of halogens.

10. The method of claim 1, wherein the electrolyzed carrier fluid comprises as least one additive, the additive being silica.

11. The method of claim 1, wherein the electrolyzed carrier fluid comprises a monovalent hydroxide brine.

12. A system for extracting an oil component from a plant-based material, the system comprising:
a contacting vessel for contacting plant-based material with an electrolyzed carrier fluid having a potential in the range of from −700 mV to −1000 mV;
a first separation vessel for separating a mixture of the electrolyzed carrier fluid and oil separated from the plant-based material from the plant-based material; and
a second separation vessel for separating the mixture into an oil component and an electrolyzed carrier fluid component.

13. The system of claim 12, further comprising:
an electrolyzation unit for producing the electrolyzed carrier fluid from a hydroxide brine.

14. The system of claim 13, wherein the electrolyzation unit is a membrane-less electrolyzation unit.

15. The system of claim 13, wherein the electrolyzation unit comprises a hydroxide brine inlet, a reduced electrolyzed carrier fluid outlet, and an oxidized carrier fluid outlet, the reduced electrolyzed carrier fluid outlet being in fluid communication with the contacting vessel.

16. The system of claim 15, further comprising a halogen removal unit, the halogen removal unit configured to receive the reduced electrolyzed carrier fluid from the reduced electrolyzed carrier fluid outlet and remove halogens from the reduced electrolyzed carrier fluid.

17. The system of claim 16, wherein the halogen removal unit comprises a granulated activated carbon unit.

18. The system of claim 15, wherein the oxidized electrolyzed carrier fluid outlet is in fluid communication with the hydroxide brine inlet.

19. The system of claim 18, further comprising a halogen removal unit, the halogen removal unit configured to receive the oxidized electrolyzed carrier fluid from the oxidized electrolyzed carrier fluid outlet and remove halogens from the oxidized electrolyzed carrier fluid.

20. The system of claim 19, wherein the halogen removal unit comprises a granulated activated carbon unit.
